(19) United States
(12) Patent Application Publication
(10) Pub. No.: US 2015/0237326 A1
(43) Pub. Date: Aug. 20, 2015

(54) SOLE CHANNEL 3D IMAGE CAPTURE APPARATUS

(71) Applicant: 3M INNOVATIVE PROPERTIES COMPANY, St. Paul, MN (US)

(72) Inventors: Zhisheng Yun, Woodbury, MN (US); James L. Graham, II, Woodbury, MN (US); Shannon D. Scott, Hudson, WI (US)

(73) Assignee: 3M INNOVATIVE PROPERTIES COMPANY, St. Paul, MN (US)

(21) Appl. No.: 14/180,834

(22) Filed: Feb. 14, 2014

(51) Int. Cl. H04N 13/02; H04N 5/225

(52) U.S. Cl. CPC H04N 13/0207; H04N 5/2253; H04N 5/2254; G02B 3/12

(57) ABSTRACT

A 3D image apparatus using a single optical channel for capturing multiple view-angle images of an object for use in generating a 3D image or model of the object. The apparatus includes within the optical train an active optical component, an aperture plate having an aperture, a lens for focusing light from the aperture, and an image sensor. The active optical component has a changeable shape or position for providing first and second optical wavefronts through the aperture and focused by the lens onto the image sensor from first and second view angles of the object. The second optical wavefront is shifted by the active optical component on the image sensor with respect to the first optical wavefront in order to provide multiple view-angle images along the single optical channel, which can be used to generate a 3D model or image of the object.

### BACKGROUND

A multi-channel 3D camera system obtains digital images of an object from multiple view points, which can be used to generate a 3D image of the object. These multi-channel cameras have advantages of high accuracy and non-moving parts compared with other methods for obtaining 3D images. However, the use of multiple channels requires a particular amount of physical space to accommodate those channels within a scanning wand incorporating the 3D camera system, which can affect the size and form factor of the wand. The complexity of using multiple channels can also increase the cost of the 3D system. As a result, the 3D image capturing market is driving to develop more compact and cost-effective 3D cameras, while maintaining the high accuracy of them. Accordingly, a need exists for such an improved 3D camera system.

### SUMMARY

A first sole channel 3D image capture apparatus, consistent with the present invention, includes an image sensor, a lens adjacent the image sensor, and an active optical component adjacent the lens and opposite the image sensor. An aperture component is located between the active optical component and the lens, and the aperture component has an aperture for allowing passage of light to the image sensor. The active optical component is changeable between first and second shapes. The first shape provides a first optical wavefront through the aperture and lens to the image sensor from a first view angle of an object, and the second shape provides a second optical wavefront through the aperture and lens to the image sensor from a second view angle of the object. The second optical wavefront is shifted by the active optical component on the image sensor with respect to the first optical wavefront in order to provide multiple view-angle images along a single optical channel.

A second sole channel 3D image capture apparatus, consistent with the present invention, includes an image sensor, a lens adjacent the image sensor, and a mirror adjacent the lens and opposite the image sensor. An aperture component is located between the mirror and the lens, and the aperture component has an aperture for allowing passage of light to the image sensor. The mirror is changeable between first and second positions. The first position provides a first optical wavefront through the aperture and lens to the image sensor from a first view angle of an object, and the second position provides a second optical wavefront through the aperture and lens to the image sensor from a second view angle of the object. The second optical wavefront is shifted by the mirror on the image sensor with respect to the first optical wavefront in order to provide multiple view-angle images along a single optical channel.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a single optical channel 3D system using an active optical wedge;

FIG. 2 is a diagram of a single optical channel 3D system using an electrically driven mirror or a micro-mirror array;

FIG. 3 is a diagram illustrating an active optical wedge located in the middle of the lens groups for a single channel 3D system;

FIG. 4 is a diagram illustrating an active optical wedge located inside of the first lens group for a single channel 3D system; FIG. 5 is a diagram illustrating an active optical wedge located in the front of the optical train for a single channel 3D system;

FIG. 6A is a diagram illustrating a liquid lens in an active optical wedge changing tilt along a first axis;

FIG. 6B is a diagram illustrating the liquid lens in an active optical wedge varying focus;

FIG. 6C is a diagram illustrating the liquid lens in an active optical wedge changing tilt along a second axis; and

FIG. 7 is a diagram illustrating image data regions on an image sensor for obtaining multiple views in a single channel 3D system.

### DETAILED DESCRIPTION

Embodiments of the present invention use a single optical channel to capture multiple views of an object from varying viewpoints that can be used to generate a 3D image of it. The single optical channel can use, for example, an active optical wedge or a moveable mirror to obtain the multiple views by creating virtually spatially separated apertures in a time sequential manner. An electronic digital imager sensor captures a scene of a 3D object through the multiple virtual apertures to obtain different view-angle images. Software algorithms can rebuild the 3D scene into a 3D image or model based on the captured different view-angle images of the scene.

Systems to generate 3D images or models based upon image sets from multiple views are disclosed in U.S. Pat. Nos. 7,956,862 and 7,605,817, both of which are incorporated herein by reference as if fully set forth. These systems can be included in a housing providing for hand-held use, and an example of such a housing is disclosed in U.S. Pat. No. D674,091, which is incorporated herein by reference as if fully set forth.

FIG. 1 is a diagram of a single optical channel 3D system 10 using an active optical wedge. System 10 includes an active optical wedge 16, an aperture component 18 having an aperture, a lens 20, and a digital image sensor 22. As shown in FIG. 1, an object 12 is located in the front of single channel optical system 10, where line 14 represents the primary optical path or central axis. Image sensor 22 is positioned at the image plane. Active optical wedge 16, as controlled by a signal from wedge control 17, functions as a thin optical plate when no electrical power is applied to it and converts to an optical wedge when it receives electrical power. Lens 20 focuses an optical wavefront from the aperture in aperture component 18 onto image sensor 22, which provides a signal 24 representing a digital image of object 12.

As shown in FIG. 1, assuming A(x, y, z) is one point on the surface of object 12, point A will form an image A′(x′, y′, Δy=0) on image sensor 22 when there is no power applied to active optical wedge 16. Accordingly, when electrical power is applied to active optical wedge 16 from wedge control 17, the aperture position inside the optical channel shifts from P′ to P″ so that a different view-angle image A″(x″, y″, Δy) forms on image sensor 22. Analyzing the shift Δy from A″(x″, y″, Δy) with respect to A′(x′, y′, Δy=0), the object A spatial location A(x, y, z) can be determined. By repeatedly obtaining images of the object at different views and repeating this computation, a 3D image or model of the object can be generated.

The components of system 10 can be contained within a housing 11, which can have a variety of shapes. For example, housing 11 can be configured for hand-held use. Housing 11 can include a window 13 for receiving light from the object, and window 13 can be implemented, for example, as an aperture in housing 11 or with a transparent piece of material. A light source 15, such as one or more light emitting diodes (LEDs), can optionally be located on the housing adjacent window 13 for illuminating the object. System 10 can optionally include a mirror in front of wedge 16 and within or adjacent housing 11 to image the object at a non-zero angle to central axis 14, for example downward from housing 11 when scanning an object.

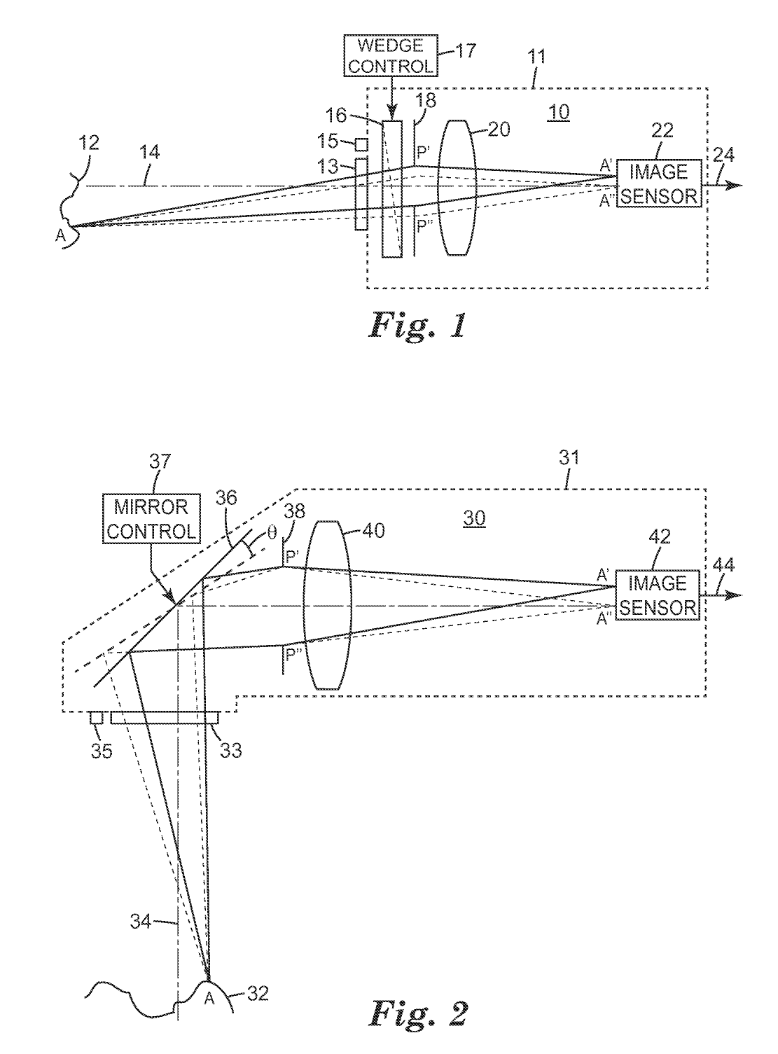

FIG. 2 illustrates another configuration of a single channel 3D system 30, using an electrically driven mirror or a micro-mirror array. System 30 includes a mirror 36, an aperture component 38 having an aperture, a lens 40, and a digital image sensor 42. As shown in FIG. 2, an object 32 is located in the front of single channel optical system 30, where line 34 represents the primary optical path or central axis. Lens 40 focuses an optical wavefront from the aperture in aperture component 38 onto image sensor 42, which provides a signal 44 representing a digital image of object 32.

The electrically driven mirror or micro-mirror array 36 has on and off status as controlled by mirror control 37. When mirror 36 is on by receiving an electrical signal from mirror control 37, the single channel optics captures the object point A(x, y, z) wavefront and forms an image A′(x′, y′, Δy=0) on image sensor 42. When the mirror is off and shifts to a different position as represented by angle Θ, the optical channel samples a different wavefront of A(x, y, z) and forms an image A″(x″, y″, Δy) on image sensor 42. Analyzing the shift Δy from A″(x″, y″, Δy) with respect to A′(x′, y′, Δy=0), the object A spatial location A(x, y, z) can be determined. By repeatedly obtaining images of the object at different views and repeating this computation, a 3D image or model of the object can be generated. An example of a rotatable mirror is the Digital Micromirror Device (DMD) product by Texas Instruments Incorporated.

The components of system 30 can be contained within a housing 31, which can have a variety of shapes. For example, housing 31 can be configured for hand-held use. Housing 31 can include a window 33 for receiving light from the object, and window 33 can be implemented, for example, as an aperture in housing 31 or with a transparent piece of material. A light source 35, such as one or more LEDs, can optionally be located on the housing adjacent window 33 for illuminating the object.

The active optical wedge shown in FIG. 1 is an example of an active optical component, which includes any optical component changeable between at least first and second different shapes or positions to provide for different view-angle images of an object. The mirror shown in FIG. 2 can be implemented with a single mirror or an array of micro-mirrors, and the mirrors can be implemented with any surface or material having sufficiently reflectivity to capture the scene as digital images from the image sensor. Although the systems in FIGS. 1 and 2 use a single optical channel, such systems can optionally have additional optical channels for other purposes. The wedge control 17 and mirror control 37 shown in FIGS. 1 and 2, respectively, can be implemented as a power source to either apply an electrical signal or not apply the electrical signal. The power source for that control, and for systems 10 and 30, can be provided, for example, on the same electrical connection as for the signals 24 and 44. Alternatively, electrical power to the systems and the signals for providing the digital images from the image sensors can be provided on different electrical connections. The system can alternatively have wireless connections for receiving control signals and providing the digital images.

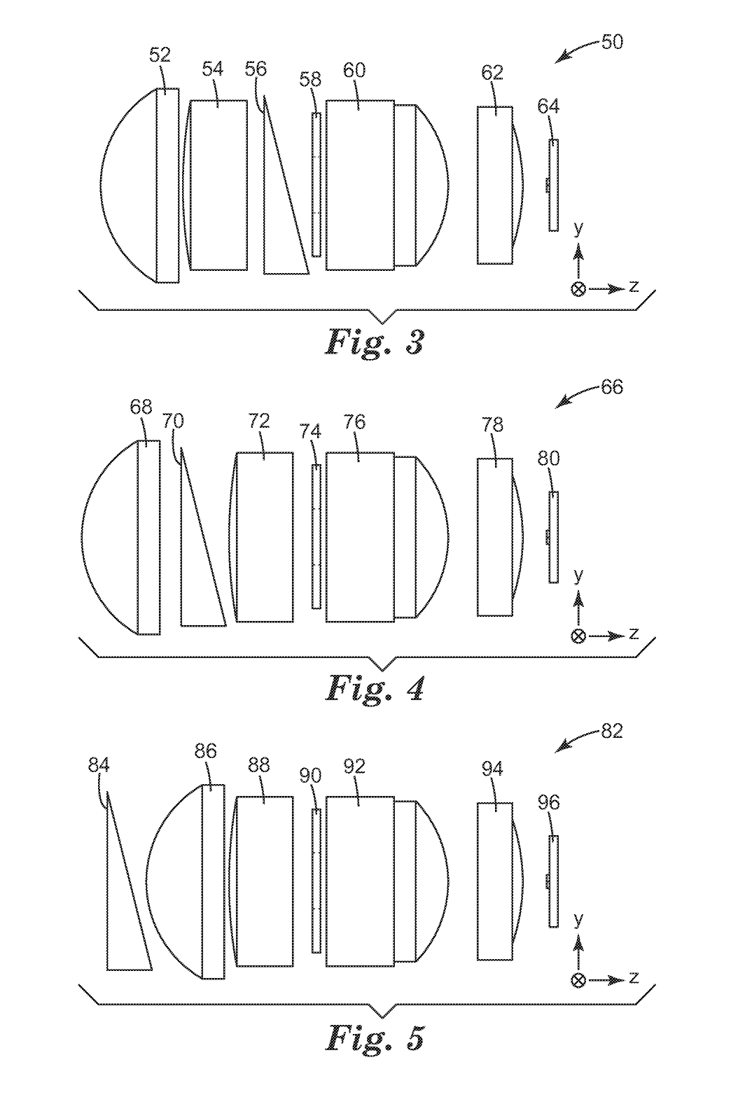

The active optical wedge for the embodiment shown in FIG. 1 can be located at various positions within the optical train of a single channel system, as shown in FIGS. 3-5. FIG. 3 is a diagram illustrating a system 50 where an active optical wedge 56 is located in the middle of the lens groups in front of the aperture. System 50 includes, arranged as shown, a first lens group formed by lenses 52 and 54, active optical wedge 56, an aperture component 58 having an aperture, a second lens group formed by lenses 60 and 62, and a digital image sensor 64. FIG. 4 is a diagram illustrating a system 66 where an active optical wedge 70 is located inside of the first lens group. System 66 includes, arranged as shown, a first lens group formed by lenses 68 and 72, active optical wedge 70 between lenses 68 and 72, an aperture component 74 having an aperture, a second lens group formed by lenses 76 and 78, and a digital image sensor 80. FIG. 5 is a diagram illustrating a system 82 where an active optical wedge 84 is located in the front of the optical train. System 82 includes, arranged as shown, active optical wedge 84, a first lens group formed by lenses 86 and 88, an aperture component 90 having an aperture, a second lens group formed by lenses 92 and 94, and a digital image sensor 96.

In optical systems 50, 66, and 82, the active optical wedge provides an optical wavefront along the z-axis through the aperture of the aperture component and focused onto the image sensor by the lenses. By changing states between on and off positions, the active optical wedge provides for shifted images of an object from the same perspective along a single optical channel and effectively provides two virtual channels. A single channel 3D system can alternatively use multiple active optical wedges or other active optical components. The aperture component in the single channel systems can be implemented with, for example, an opaque plate having a substantially circular aperture or an aperture of other shapes.

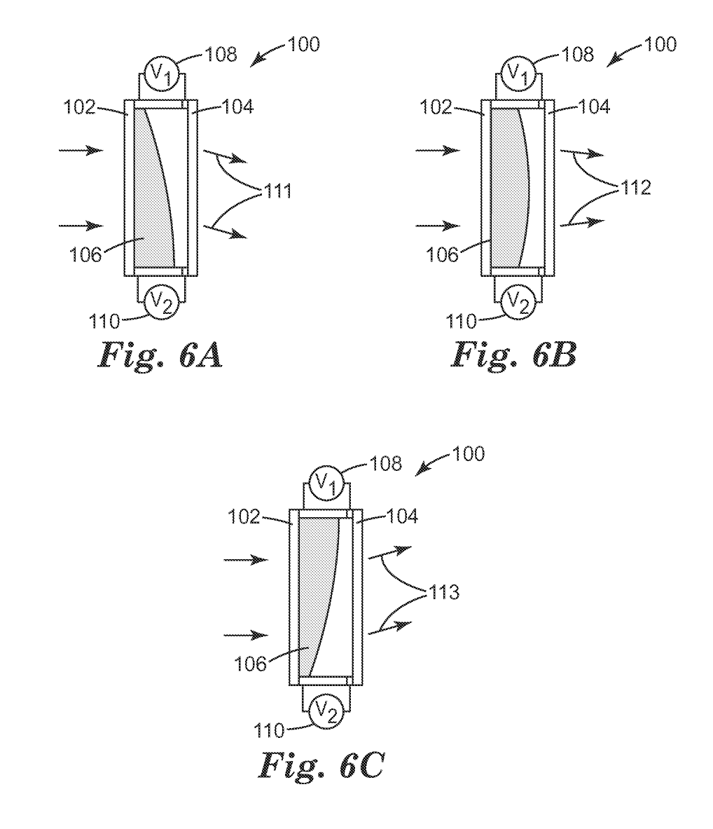

FIGS. 6A-6C are diagrams illustrating the operation of an exemplary active optical wedge 100 used in a single channel 3D system. Active optical wedge 100 includes front and back transparent plates 102 and 104, respectively, for mechanical support. A liquid lens 106 is located between plates 102 and 104, and power sources 108 (V₁) and 110 (V₂) control a shape of liquid lens 106. FIG. 6A illustrates liquid lens 106 in active optical wedge 100 changing tilt along a first axis, as represented by lines 111, when V₂<V₁ (for example, V₁=60 V and V₂=30 V). FIG. 6B illustrates liquid lens 106 in active optical wedge 100 varying focus, as represented by lines 112, when V₂=V₁ (for example, V₁=45 V and V₂=45 V). FIG. 6C illustrates liquid lens 106 in active optical wedge 100 changing tilt along a second axis, as represented by lines 113, when V₂>V₁ (for example, V₁=30 V and V₂=60 V). By changing the tilt, and possibly the focus, liquid lens 106 in active optical wedge 100 can generate multiple view-angle images along a single optical channel. An example of such a liquid lens is the Liquid Lens for Optical Image Stabilization (OIS) product from Varioptic (part of Parrot SA).

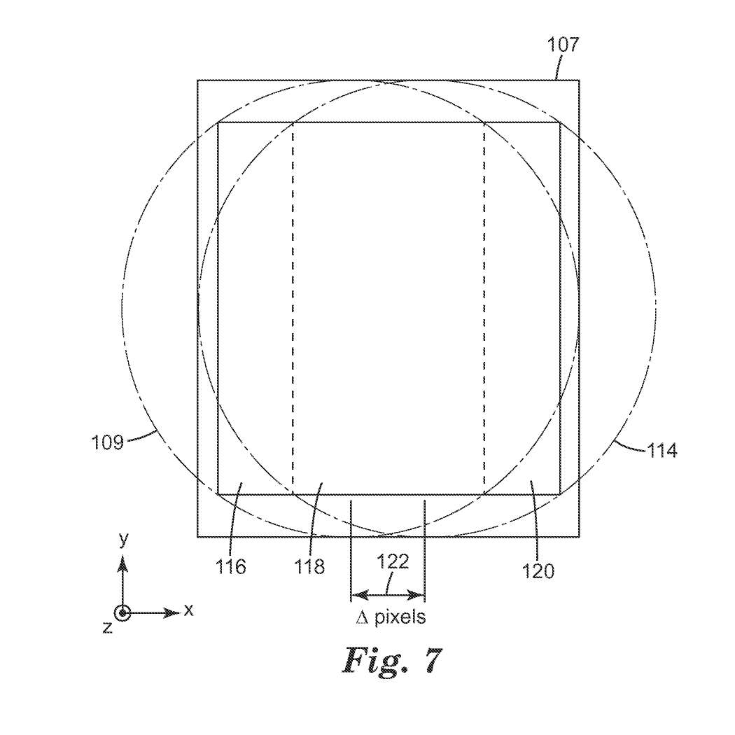

FIG. 7 is a diagram illustrating image data regions on a digital image sensor 107 for obtaining multiple views in a single channel 3D system. Image sensor 107 corresponds with image sensors 22 and 42 in systems 10 and 30, respectively. Images of the captured object formed on the sensor plane of image sensor 107 can be partitioned as shown in FIG. 7. A first view-angle image 109 is captured in regions 116 and 118 of image sensor 107, and a second view-angle image 114 is captured in regions 118 and 120 of image sensor 107. Region 118 represents the overlap between the first and second views 109 and 114 on image sensor 107. Distance 122 represents and amount of shift (A pixels) in the pixels between the first and second view-angle images. This shift (A pixels) can be used, as indicated above, to rebuild a 3D image of the captured scene.

Image sensor 107 can be implemented with, for example, any digital imager such as a CMOS or CCD sensor having approximately 1.6-3.0 mega-pixels or other resolutions. The image sensor is positioned with a single channel 3D imager to conjugate with the nominal object plane. The 3D system can generate a 3D image or model at a particular volume of object space depending on the optical design. For example, the system can map 3D object space from 5 mm to 15 mm if the optical system design has a focal length of approximately 3.0 mm.

The image sensor can include a single sensor, as shown, partitioned into multiple partially overlapping image data regions. Alternatively, the image sensor can be implemented with multiple sensors with the image data regions distributed among them.

1. A sole channel 3D image capture apparatus, comprising:
an image sensor;
a lens adjacent the image sensor;
an active optical component adjacent the lens and opposite the image sensor; and
an aperture component between the active optical component and the lens, the aperture component having an aperture for allowing passage of light to the image sensor,
wherein the active optical component is changeable between a first shape and a second shape, the first shape provides a first optical wavefront through the aperture and the lens along a single optical channel to the image sensor from a first view angle of an object, the second shape provides a second optical wavefront through the aperture and the lens along the single optical channel to the image sensor from a second view angle of the object, and the second optical wavefront is shifted by the active optical component on the image sensor with respect to the first optical wavefront.

2. The apparatus of claim 1, wherein the first shape comprises a plate and the second shape comprises a wedge.

3. The apparatus of claim 1, wherein the active optical component comprises a liquid lens changeable between the first and second shapes based upon an applied electrical signal.

4. The apparatus of claim 1, wherein the image sensor comprises a single sensor partitioned into multiple overlapping image data regions.

5. The apparatus of claim 1, further comprising another lens adjacent the active optical component and opposite the aperture component.

6. The apparatus of claim 1, further comprising another lens, wherein the another lens comprises first and second lenses with the active optical component positioned between the first and second lenses, and the second lens positioned between the active optical component and the aperture component.

7. The apparatus of claim 1, further comprising another lens between the active optical component and the aperture component.

8. The apparatus of claim 1, wherein the aperture component comprises a opaque plate, and the aperture has a substantially circular shape within the plate.

9. The apparatus of claim 1, wherein the lens comprises a plurality of lenses.

10. The apparatus of claim 1, further comprising a housing containing, along the single optical channel, the image sensor, the lens, the active optical component, and the aperture component.

11. A sole channel 3D image capture apparatus, comprising:
an image sensor;
a lens adjacent the image sensor;
a mirror adjacent the lens and opposite the image sensor; and
an aperture component between the mirror and the lens, the aperture component having an aperture for allowing passage of light to the image sensor,
wherein the mirror is changeable between a first position and a second position, the first position provides a first optical wavefront through the aperture and the lens along a single optical channel to the image sensor from a first view angle of an object, the second position provides a second optical wavefront through the aperture and the lens along the single optical channel to the image sensor from a second view angle of the object, and the second optical wavefront is shifted by the mirror on the image sensor with respect to the first optical wavefront.

12. The apparatus of claim 11, wherein the mirror is rotatable between the first and second positions.

13. The apparatus of claim 11, wherein the mirror is changeable between the first and second positions based upon an applied electrical signal.

14. The apparatus of claim 11, wherein the image sensor comprises a single sensor partitioned into multiple overlapping image data regions.

15. The apparatus of claim 11, wherein the aperture component comprises a opaque plate, and the aperture has a substantially circular shape within the plate.

16. The apparatus of claim 11, further comprising a housing containing, along the single optical channel, the image sensor, the lens, the mirror, and the aperture component.

17. A method for receiving multiple view-angle images through a sole channel, comprising:
providing an image sensor;
receiving at the image sensor a first optical wavefront from a first view angle of an object and along a single optical channel; and
receiving at the image sensor a second optical wavefront from a second view angle of the object and along the single optical channel,
wherein the first and second optical wavefronts are provided through an active optical component changeable between first and second shapes to provide, respectively, the first and second optical wavefronts,
wherein the second optical wavefront is shifted by the active optical component on the image sensor with respect to the first optical wavefront.

18. The method of claim 17, wherein the receiving steps comprise receiving the first and second optical wavefronts through a liquid lens changeable between the first and second shapes based upon an applied electrical signal.

19. A method for receiving multiple view-angle images through a sole channel, comprising:
providing an image sensor;
receiving at the image sensor a first optical wavefront from a first view angle of an object and along a single optical channel; and
receiving at the image sensor a second optical wavefront from a second view angle of the object and along the single optical channel,
wherein the first and second optical wavefronts are provided from a mirror changeable between first and second positions to provide, respectively, the first and second optical wavefronts,
wherein the second optical wavefront is shifted by the mirror on the image sensor with respect to the first optical wavefront.

20. The method of claim 19, wherein the receiving steps comprise receiving the first and second optical wavefronts from the mirror by rotating the mirror between the first and second positions based upon an applied electrical signal.
